(19) United States
(12) Patent Application Publication
(10) Pub. No.: US 2025/0062998 A1
(43) Pub. Date: Feb. 20, 2025

(54) SERVER NODE, CLIENT DEVICE, AND METHODS PERFORMED THEREIN FOR HANDLING MEDIA RELATED SESSION

(71) Applicant: Telefonaktiebolaget LM Ericsson (publ), Stockholm (SE)

(72) Inventors: Andras Kern, Budapest (HU); Balazs Peter Gero, Budapest (HU)

(21) Appl. No.: 18/723,122

(22) PCT Filed: Dec. 23, 2021
(86) PCT No.: PCT/SE2021/051311

§ 371 Date: Jun. 21, 2024

(51) Int. Cl. H04L 47/30; H04L 47/2416; H04L 65/75

(52) U.S. Cl. CPC H04L 47/30; H04L 47/2416; H04L 65/762

(57) ABSTRACT

Embodiments herein relate, in some examples, to a method performed by a server node (12) for handling a media related session with a client device (10) in a communication network. The server node receives, from the client device (10), an indication of a buffer size related to the media related session. The server node (12) triggers an increase of one or more compute resources in the communication network to handle the media related session based on the received indication.

### TECHNICAL FIELD

Embodiments herein relate to a server node, a client device, and methods performed therein for communication networks. Furthermore, a computer program product and a computer readable storage medium are also provided herein. In particular, embodiments herein relate to handling media related sessions in a communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by a radio network node such as an access node, e.g., a Wi-Fi access point or a radio base station (RBS), which in some radio access technologies (RAT) may also be called, for example, a NodeB, an evolved NodeB (eNB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

Media related sessions such as a gaming session, a media interactive session, a virtual reality session, or an augmented reality session, may today be handled in a cloud computing environment. In the example of gaming, a cloud gaming service enables users to play games requiring high compute resources on a client device that is not capable of running the game anyway, such as mobile phones, televisions, or older laptops. The concept introduces a split where compute intense game simulations and video rendering are executed at a server node deployed in a data center; while the client device only depicts the remotely rendered video to the user and the user interactions are sent back to the server node. This split requires a continuous video stream from the server node to the client device with stable and low latency in order to fit into the end-to-end (e2e) game latency constraints. The game latency is the time elapsed from a user trigger action, e.g., pressing a button, until the effect of that trigger action appears on the screen.

The radio environment of mobile networks results in continuous changes in the observed transmission rates and latencies. These changes can cause loss or late reception of video packets of a media session. In either case, the client device will not be able to decode the corresponding video frame in time and will be required to replay the last video frame to the user. It may also be possible that the frame after the delayed one is received in time and the client device should display only one of those frames and thus it ignores the other. Such repetitions or skips cause “hiccups” in the video streams annoying the user or may even affect the gaming session. State of the art solutions make use the following components to decrease the number of such video frame repetitions and skips.
Video rate adaptation techniques, such as shown in Johansson and Z. Sarker, “Self-Clocked Rate Adaptation for Multimedia” IETF RFC 8298 December, 2017, monitor the available latency and throughput of the network between the sender and the receiver, and may adjust the video stream rate accordingly.
A client device may implement a jitter buffer that stores all incoming video packets for a certain period, and it passes the packets to the decoder after that period. This artificial delay can hide the variances of packet transport latency caused by a network jitter. The longer the jitter buffer is, the larger network jitters can be compensated without frame repetition/skip. The downside is that jitter buffer increases the user's perceived game latency deteriorating the user experience.
Adaptive jitter buffers have an additional control mechanism that tunes the artificial delay, referred to as target delay, based on video packet statistics, like time elapsed between two received video packets, one-way network latency, etc. This control mechanism may be configured by defining an interval from which it can select target delay, for example, to limit the introduced delay.

FIG. 1 depicts components of an exemplary implementation of a cloud game service.

A game server implements a renderer that generates the video frames of the game. The video encoder component is in charge of compressing the video frames and converting the frames into a series of video packets such as real-time transport protocol (RTP) packets. The streamer component sends the video packets over a communication network to a game client. A game stream thus comprises one or more video packets. The video packets may be transmitted as Internet Protocol (IP) packets and may use the User Datagram Protocol (UDP) or Transmission Control Protocol (TCP) as the transport protocol. In some embodiments, the Real Time Transport protocol (RTP) and Real Time Transport Control protocol (RTCP) are used as a session protocol to encapsulate H.264, or other, video image information payloads.

The game client implements a receiver component to receive and process the video packets forming the game stream as well as to generate game stream feedback in connection with the game streams. The game stream feedback may carry information whether the video packet with a sequence number is received, network congestion was observed, etc. See for example, Johansson and Z. Sarker, “Self-Clocked Rate Adaptation for Multimedia” IETF RFC 8298 December, 2017.

The game client also implements an adaptive jitter buffer that besides tuning the target delay, generates jitter buffer delay target update messages to the game server indicating that it has tuned the jitter buffer delay target parameter.

In U.S. Pat. No. 9,363,187 B2, it is described a technique where the sender side, based on measured downlink delay statistics, instructs the client to switch the jitter buffer component on or off.

In U.S. Pat. No. 20,190,164518 A1, the client device monitors the arrival times of the video packets and the frames formed by those packets encoding the video stream. The client device further adapts its jitter buffer configuration based on the monitoring, and if the jitter adaptation parameters change, the client device generates and sends feedback to the game server including jitter and buffer latency parameters. The feedback also carries frame transmission related statistics. The game server, based on the information carried in the feedback, aligns the encoding and frame rate parameters of the cloud gaming application at the game server.

Some game genres demand end-to-end round-trip times lower than 100 ms that represent a strict upper limit on the communication network and jitter buffer added latency requirements. Jitter buffer configurations, which eliminate the network jitter resulted video glitches, may violate the requirements. Such disruptions result in end-to-end round-trip times over 100 ms that deteriorated game experience.

When the adaptive jitter buffers increase the target delay parameter, a frame replication may happen as the jitter buffer will delay the video packets belonging to the next frame. On the other hand, decreasing the target delay may result in skipping a frame, since jitter buffer will pass packets belonging to multiple frames at the same time. Such jitter buffer adaptation may often happen due to the changing radio conditions. The resulted frequent frame skips, and repetitions will deteriorate the end user quality of experience.

Since adaptive jitter buffers decrease the effects of jitter by increasing the network delay, the end user perceived end-to-end latency may breach the latency requirements.

This in turn also decreases its quality of experience.

### SUMMARY

An object of embodiments herein is to provide a mechanism for improving operations of a media related session in a communication network in an efficient manner.

The object may be achieved by providing a method performed by a server node for handling a media related session with a client device in a communication network. The server node receives, from the client device, an indication of a buffer size related to the media related session. The server node further triggers an increase of one or more compute resources in the communication network to handle the media related session based on the received indication.

The object may be achieved by providing a method performed by a client device for handling a media related session with a server node in a communication network. The client device transmits to the server node, an indication of a buffer size related to the media related session. The client device further receives, from the server node, a reconfiguration message indicating to the client device not to decrease the buffer size during the media related session.

It is furthermore provided herein a computer program product comprising instructions, which, when executed on at least one processor, cause the at least one processor to carry out the method above, as performed by the client device and the server node, respectively. It is additionally provided herein a computer-readable storage medium, having stored thereon a computer program product comprising instructions which, when executed on at least one processor, cause the at least one processor to carry out the method above, as performed by the client device and the server node, respectively.

It is herein provided a server node for handling a media related session with a client device in a communication network. The server node is configured to receive, from the client device, an indication of a buffer size related to the media related session; and to trigger an increase of one or more compute resources in the communication network to handle the media related session based on the received indication.

It is herein also provided a client device for handling a media related session with a server node in a communication network. The client device is configured to transmit to the server node, an indication of a buffer size related to the media related session; and to receive, from the server node, a reconfiguration message indicating to the client device not to decrease the buffer size during the media related session.

Embodiments herein propose a method for aligned management of computing resources associated to the server node, such as a game server, and of the buffer at the client device connected to the server node. In a response to a buffer adaptation event at the client device that increases the delay target parameter, additional resources, e.g., computing resources such as graphical processing units (GPU), may be requested for the server node in order to compensate the increase of the buffer introduced latency.

Besides, a reconfiguration of the client device may be initiated in parallel to the resource update procedure to prevent the buffer to decrease the target delay below the reported value. In some embodiments, when the resource update procedure fails to provide the requested amount of compute resources, a second buffer reconfiguration may be initiated to make the buffer target delay bounds are in sync with the compute latency provided by the available resources.

The server node and the methods disclosed herein adjust the compute resources in response to changes of the buffer at the client device that increases the jitter buffer target delay parameter. The objective of a resource update is to compensate for the latency increase caused by the buffer. Some buffer adaptations may be configured to only increase the target delay, to cater for forthcoming high jitter cases during the game session; then initiating buffer reconfiguration is not needed. Thus, embodiments herein efficiently improve operations of a media related session in the communication network.

### BRIEF DESCRIPTION OF THE DRAWINGS

Embodiments will now be described in more detail in relation to the enclosed drawings, in which:

FIG. 1 shows components of an exemplary implementation of a cloud game service according to prior art;

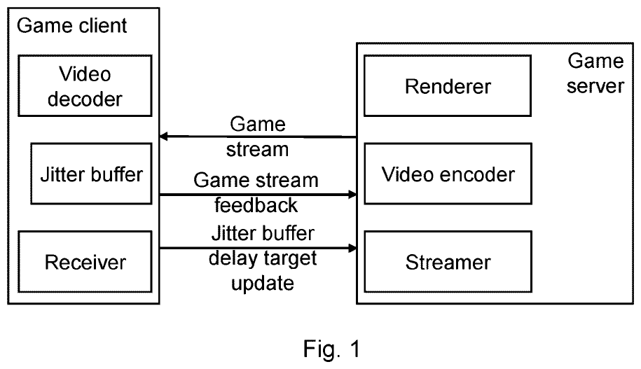

FIG. 2 shows a schematic overview depicting a communication network according to embodiments herein;

FIG. 3 shows a combined flowchart and signalling scheme according to embodiments herein;

FIG. 4 shows a schematic flowchart depicting a method performed by a server node according to embodiments herein;

FIG. 5 shows a schematic flowchart depicting a method performed by a client device according to embodiments herein;

FIG. 6 shows a block diagram depicting components according to some embodiments herein;

FIG. 7 shows a schematic flowchart depicting a method according to some embodiments herein;

FIG. 8 shows a schematic flowchart depicting a method according to some embodiments herein;

FIGS. 9a-9b show block diagrams depicting a server node according to embodiments herein; and

FIGS. 10a-10b show block diagrams depicting a client device according to embodiments herein.

### DETAILED DESCRIPTION

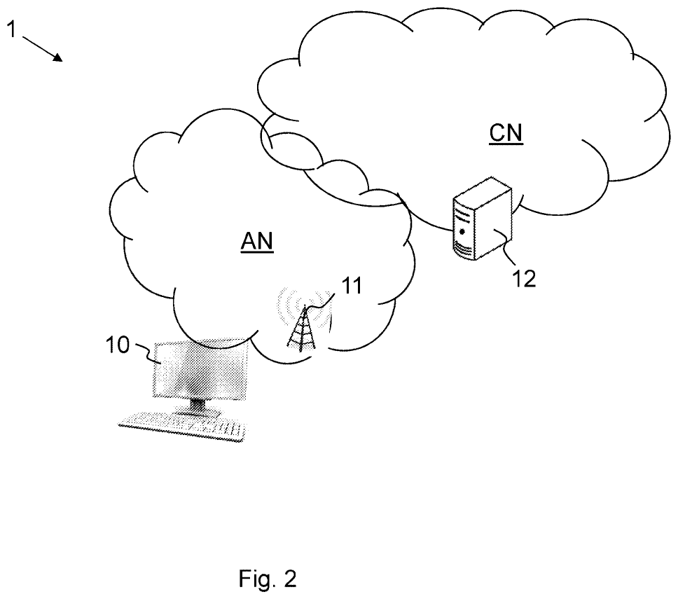

Embodiments herein relate to communication networks in general. FIG. 2 is a schematic overview depicting a communication network 1. The communication network 1 may be any kind of communication network such as a wired communication network and/or a wireless communication network comprising, e.g., a radio access network (RAN) and a core network (CN). The communication network may comprise processing units such as one or more servers or server farms providing compute capacity and may comprise a cloud environment comprising compute capacity in one or more clouds. The communication network 1 may use one or a number of different technologies, such as packet communication, Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the communication network 1, devices, e.g., a client device 10 such as a computer or a wireless communication device, e.g., a user equipment (UE) such as a mobile station, a non-access point (non-AP) station (STA), a STA, and/or a wireless terminal, communicate via one or more Access Networks (AN), e.g. RAN, to one or more core networks (CN). It should be understood by the skilled in the art that “client device” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node. In case the AN is a RAN the communication network 1 may comprise a radio network node 11 providing, e.g., radio coverage over a geographical area, a service area, or a first cell, of a radio access technology (RAT), such as NR, LTE, Wi-Fi, WiMAX or similar. The radio network node 11 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The radio network node 11 may be referred to as a serving network node wherein the service area may be referred to as a serving cell or primary cell, and the serving network node communicates with the UE 10 in form of DL transmissions to the UE 10 and UL transmissions from the UE 10.

According to embodiments herein the client device 10 may perform a media related session such as a gaming session with a server node 12 such as a game or gaming server providing one or more gaming sessions for the client device 10 or a media server providing an interactive media, for example, a medical application streaming a real time surgical procedure, being sensitive to jitter. The server node 12 may be a physical node or a virtualized component running on a general-purpose server, e.g., a docker container or a virtual machine. The general-purpose server or physical instantiations of the server node 12 may form a part of a cloud environment that may be part of the communication network 1. The media related session relates to a session comprising a communication of video packets such as a gaming session. The server node 12 may thus be a game server or comprise a game server that is part, or connects, to the communication network 1 through an interface. During the media related session an adaption of a buffer at the client device 10, also referred to as a jitter buffer, may be performed to increase a delay in order to cater for high jitter cases during the media related session.

It is herein proposed a method for aligned management of compute resources, such as GPU resources, associated to the server node 12 and for handling the media related session. The buffer at the client device 10 buffers video packets of the media related session. In a response to an adaptation event of the buffer at the client device 10 that increases a delay target parameter, additional compute resources, e.g., graphics processing unit (GPU) capacity, may be requested for the server node 12 in order to compensate the increase of the latency introduced by the buffer. This is referred to as resource update. In addition, a jitter buffer reconfiguration may be initiated in parallel to the resource update procedure to prevent the jitter buffer to decrease the target delay below the value reported from the client device 10.

By adding the additional compute resources, the server node 12 can decrease the computation resulted latency of the media related session. Therefore, adding the compute resources compensates the additional latency caused by the increased jitter buffer delay target, i.e., the increase of the end-to-end game latency can be minimized or even eliminated. As the increased latency is compensated, it is not necessary to immediately decrease the jitter buffer delay target when the network latency decreases. Then the resulted video glitches are eliminated.

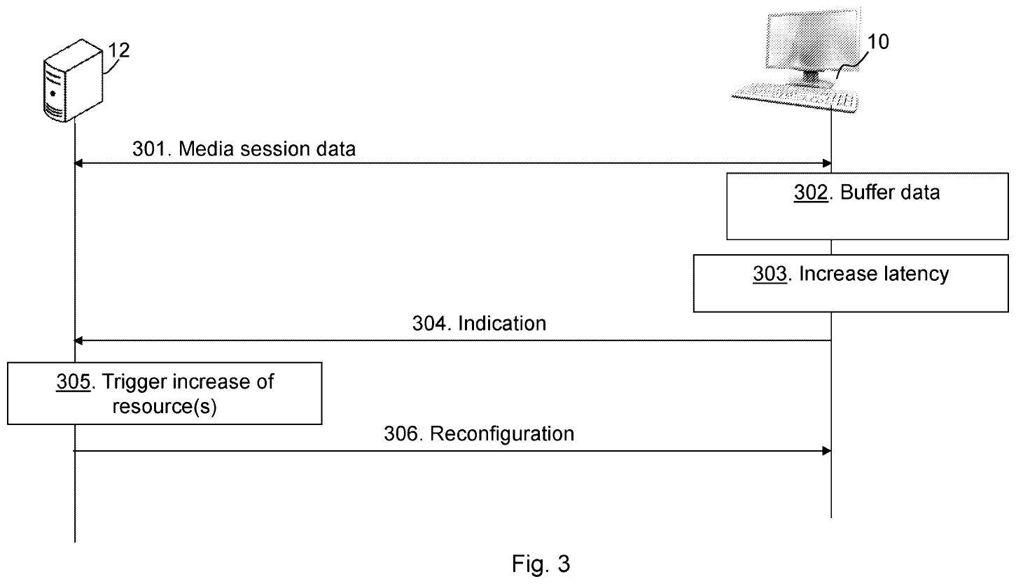

FIG. 3 is a combined flowchart and signalling scheme depicting embodiments herein.

Action 301. A media related session is executed, such as a gaming session, between the client device 10 and the server node 12. Media content data such as video packets may be transmitted during the media related session. The video packets may be transmitted as Internet Protocol (IP) packets and may use the User Datagram Protocol (UDP) or Transmission Control Protocol (TCP) as the transport protocol. Real Time Transport protocol (RTP) and Real Time Transport Control protocol (RTCP) may be used as a session protocol to encapsulate and packetize encoded video payloads, such as H.264 or H.265 video payloads.

Action 302. The client device 10 receives the media content data and buffers the media content data in a buffer, i.e., the jitter buffer introducing an artificial delay that can hide variances of packet transport latency caused by a network jitter.

Action 303. The client device 10 may monitor arrival times of the video packets. The client device 10 may then adapt its jitter buffer configuration such as its buffer size based on the monitoring, and if the buffer size changes, increase in the delay, the client device 10 may generate feedback including the buffer size.

Action 304. The client device 10 may then report or transmit one or more indications indicating the buffer size back the server node 12. The client device 10 may thus transmit the one or more indications of the buffer size to the server node 12 periodically and/or upon occurrence of an event such as buffer size above a threshold.

Action 305. The server node 12 triggers an increase of compute resources trying to compensate for the delay introduced by the increased buffer size. For example, the server node 12 may calculate an amount of compute resources based on the indicated buffer size. The objective of a resource update is to compensate for the latency increases caused by the jitter buffer. By adding additional compute resources, e.g., GPU resources, the server node 12 can decrease the computation resulted latency of the media related session. Therefore, it compensates the additional latency caused by the increased jitter buffer delay target, e.g., the increase of the end-to-end game latency can be minimized or even eliminated.

Action 306. The server node 12 may further transmit a reconfiguration back to the client device 10 indicating to the client device 10 not to decrease the buffer size during the media related session. As the increased latency is compensated, it is not necessary to immediately decrease the jitter buffer delay target when the network latency decreases. Then the resulted video glitches are eliminated. Furthermore, a subsequent radio link quality degradation may be served by the increased delay target and there is no need to increase the delay target again, so the bigger buffer is better equipped to tolerate subsequent radio rate changes and hence frame repetitions and video glitches are avoided.

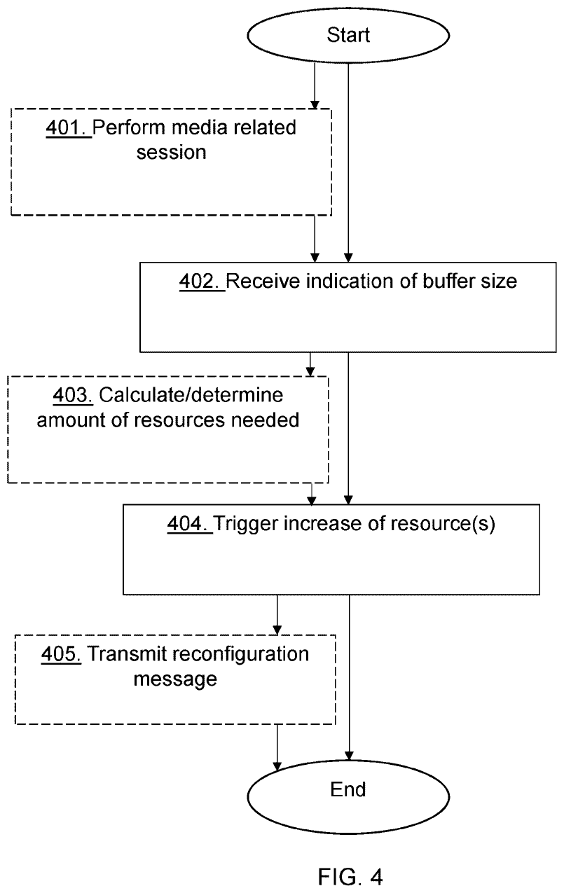

The method actions performed by the server node 12 for handling a media related session with the client device 10 in the communication network according to embodiments herein will now be described with reference to a flowchart depicted in FIG. 4. The actions do not have to be taken in the order stated below, but may be taken in any suitable order. Dashed boxes indicate optional features.

Action 401. The server node 12 may execute or perform a media related session, such as a gaming session, with the client device 10, and wherein the server node 12 transmits video packets during the media related session. Thus, the media related session may comprise a gaming session.

Action 402. The server node 12 receives from the client device 10, an indication of a buffer size related to the media related session. For example, indicating size of the jitter buffer in terms of amount of data or that a threshold has been exceeded.

Action 403. The server node 12 may calculate or determine an amount of compute resources needed based on the received indication of the buffer size.

Action 404. The server node 12 triggers an increase of one or more compute resources in the communication network to handle the media related session based on the received indication. The server node 12 may trigger the increase by sending to a resource manager, wherein the resource manager manages compute resources in the communication network, a request to add the one or more compute resources to handle the media related session. The resource manager may manage resources in the communication network that may comprise a cloud environment. Thus, the resource manager may manage resources structured in the cloud environment and/or logical resources in a part or whole of the communication network.

The server node 12 may further receive a response from the resource manager whether the request is granted or not. When the response is indicating that the request is not granted, the server node 12 may send another request to the resource manager based on the received response. It should be noted that the response may further indicate an amount of available resources and the server node 12 may then compare the available resources with an indication of latency decrease. Hence, when a resource update procedure fails to provide the requested amount of compute resources, a second jitter buffer reconfiguration may be initiated to make the jitter buffer target delay bounds in sync with the compute latency provided by the available compute resources.

It should further be noted that the server node 12 may trigger a calculation or determination of the amount resources needed, e.g., by another node, resulting in the increase of resources.

Action 405. Furthermore, the server node 12 may transmit a reconfiguration message to the client device 10 indicating to the client device 10 not to decrease the buffer size during the media related session.

It should be noted that the one or more compute resources may comprise one or more processing resources in a cloud computing environment, and the client device 10 may be a wireless communication device.

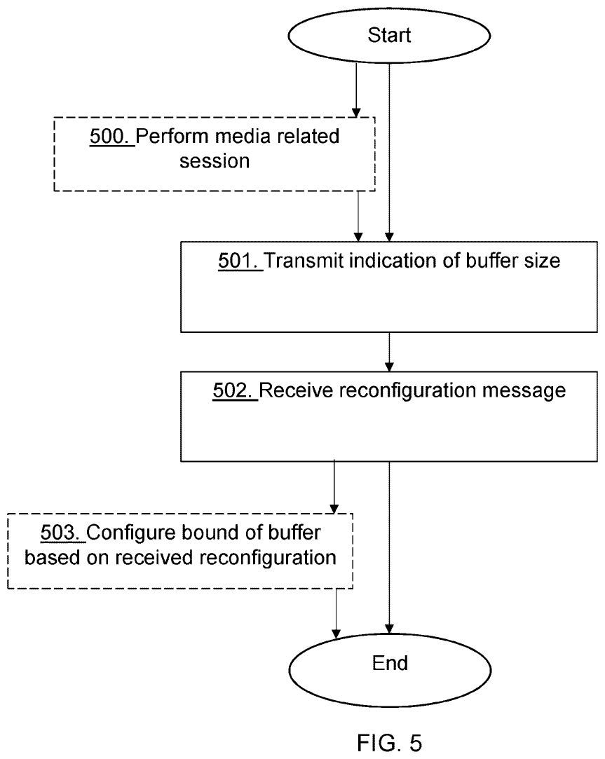

The method actions performed by the client device 10 for handling a media related session with the server node 12 in the communication network according to embodiments herein will now be described with reference to a flowchart depicted in FIG. 5. The actions do not have to be taken in the order stated below, but may be taken in any suitable order. Dashed boxes indicate optional features.

Action 500. The client device 10 may execute or perform a media related session with the server node 12, and the client device 10 may receive video packets during the media session. The media related session may comprise a gaming session.

Action 501. The client device 10 transmits to the server node 12, an indication of a buffer size related to the media related session. The client device may transmit the indication when the buffer size is above a threshold. The buffer size is related to amount of data or mount of packets in the jitter buffer at the UE 10.

Action 502. The client device 10 further receives from the server node 12, the reconfiguration message indicating to the client device 10 not to decrease the buffer size during the media related session.

Action 503. The client device 10 may configure one or more bounds of the buffer based on the received reconfiguration message. For example, the client device 10 may set a lower bound of a target delay of the jitter buffer 600 based on the received reconfiguration message. Thus, the client device 10 may configure the jitter buffer depending on the reconfiguration message. In a first example, when the reconfiguration message carries only the indication of not to decrease the jitter buffer, the client reads the current target delay of the jitter buffer and configures the lower bound for the target delay to be equal to the current value. In a second example, the reconfiguration message may carry game server calculated lower and higher bounds. Then, the client device 10 may configure the lower and higher bounds of the delay target of the jitter buffer using the values encoded in the reconfiguration message.

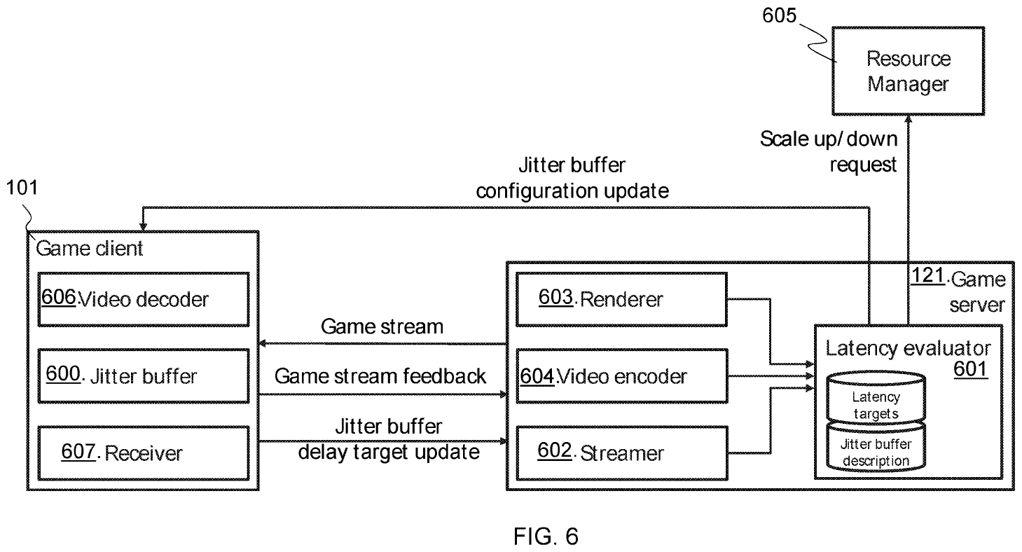

FIG. 6 shows a component executing method according to embodiments herein. It is herein disclosed a latency evaluator component 601 comprised in the server node 12 and a method that adjusts the compute resources in response a change of the buffer size of a jitter buffer 600 at the client device 10 that increases the delay parameter.

The latency evaluator 601, which is a part of a game server 121, being an example of the server node 12, determines whether an end-to-end game latency constraint cannot be fulfilled with a current jitter buffer configuration, i.e., a reported buffer size, reported by a game client 101, being an example of the client device 10, and may calculate an amount of compute resources needed to compensate the increase of the transport and client-side latencies. The adaptive jitter buffer, when it increases the target delay parameter as part of its adaptation procedure, adds to the client-side latency. The latency evaluator component 601 may interact with following components of the system.

From a streamer component 602, the latency evaluator 601 may obtain statistics on network conditions, such as the average downlink network latency added to a game stream from the game server 121. The latency evaluator 601 may further fetch frame rendering and encoding related statistics from a renderer 603 and a video encoder 604, respectively. Example statistics are times required to render or to encode a game frame. The latency evaluator 601 further processes one or more messages from the game client 101 that includes or indicates a current value of the buffer size. The latency evaluator 601 interacts with a resource manager 605. For example, the latency evaluator 601 may send to the resource manager 605, a scale up request that carries the required amount of compute resources. Furthermore, the latency evaluator 601 may store information about latency targets of the media related session such as an active cloud game session. For example, an upper bound to an end-to-end game latency that should be ensured as long as possible. The latency evaluator 601 may further store a descriptor of the jitter buffer 600 running at the corresponding game client 101. Amongst others, the latency component 601 may store committed lower and upper bounds of a target delay parameter of the jitter buffer 600, which support the correct delay target settings in a long run. When the game session starts initial values of the committed lower and upper bounds are stored in the descriptor. Note, that target delay bounds at the game client 101 may equal to a temporal one, denoted as a candidate below, for short times during which the latency evaluator 601 may wait for the scale up response of the Resource manager 605. The latency evaluator 601 may configure the jitter buffer 600 at the game client 101 through a configuration API offered by the jitter buffer 600, which implements jitter buffer configuration update request. The concrete API depends on the jitter buffer implementation, for example, a capability of setting at least a lower bound of the target delay of the jitter buffer 600. The upper bound of the target delay may also be set, when required by the API. The game client may further comprise a video decoder 606 and a receiver 607 for handling the game session.

The resource manager 605 illustrated in FIG. 6 may control the assignment of compute resources to one or more server nodes such as game servers. The resource manager 605 may accept the Scale up request from the latency evaluator 601 and may update the compute resources assigned to the game server 121. Depending on the cloud setup of compute resources, various components may implement the resource manager 605. For example, in case of ETSI network functions virtualisation infrastructure (NFVI) based cloud, the virtual infrastructure manager (VIM) component implements the resource manager 605. Note that in some implementation, intermediate elements between the resource manager 605 and the latency evaluator 601, such as element management components may be added to perform evaluation of the content of the request. In another example, the resource manager 605 is implemented by Kubernetes components handling processing units such as pods. In a further example, the resource manager 605 may be a component that oversees managing the distribution of the compute resources of the host.

The actual format and the content of the Scale up message depends on what component implements the resource manager 605. For example, in a Kubernetes environment, the Scale Up request from the latency evaluator 601 is implemented as changing the resource description of the pod or pods that represents the game server 121.

The latency evaluator 601, when it detects the change of jitter buffer delay target parameter at the corresponding game client, decides whether an end-to-end delay target defined for the game run at the game server 121 is violated. In the case of a violation, the latency evaluator 601 may initiate compute resource adjustment for the game server 121 and may update the jitter buffer configuration of the game client 101. Note that when the jitter buffer is configured to only increase the delay target during adaptation, the last step of updating the jitter buffer configuration may be omitted.

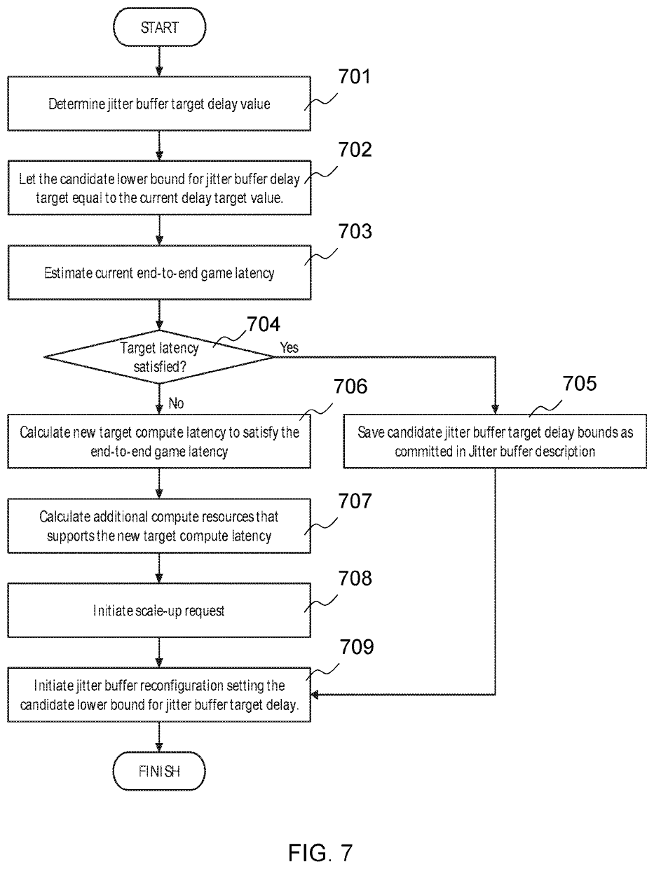

Receiving a jitter buffer configuration update message from the game client 101 may trigger an execution of a following procedure shown in FIG. 7. The details of the exemplified procedure are summarized as follows:

Action 701. First, the latency evaluator 601 may determine the current jitter buffer delay target parameter from said message.

Action 702. The latency evaluator 601 may further let a candidate for lower bound for the jitter buffer delay target equal to this determined value.

Action 703. This delay target value is used when the end-to-end game latency is estimated. When the higher bound is also managed, a new candidate for higher bound is calculated as well. For example, if the difference between the lower and higher bound becomes smaller than a threshold (let us say X milliseconds), this higher bound will be set to X milliseconds higher than the new lower bound to provide room for the jitter buffer adaptation function to further increase delay target at the game client 101. Then latency evaluator 601 may estimate the current end-to-end game latency as the sum of the initial downlink network latency for game stream, the current delay target of the jitter buffer at the game client 101, the uplink network latency from the game client 101 to the game server 121, the latencies of a game engine, the frame rendering and the frame encoding, respectively. The initial downlink network latency is the network latency measured during transmitting the first several video packets of the game stream, i.e., at the beginning of the game session. The uplink network latency can be measured as well. The game engine, the frame rendering and the frame encoding latencies are obtained from the corresponding components of the game server 121. The above estimation may require an initial downlink game stream latency measurement, because the jitter buffer absorbs the latency fluctuations observed during session.

Action 704. Once the end-to-end game latency is estimated, the latency evaluator compares it to the target value.

Action 705. When the current end-to-end game latency is smaller than the target one, the latency constraint is satisfied, so latency evaluator 601 stores the candidate lower and higher bounds for jitter buffer target delay as committed in the jitter buffer descriptor and reconfigures the jitter buffer by updating its lower and higher bounds to the candidate values.

Action 706. Otherwise, when the latency constraint has been violated, the next action is for the latency evaluator 601 to calculate the target compute latency required for the compensation. An example implementation first calculates the difference of the estimated and the target end-to-end game latencies, and then subtracts this difference from the latency introduced by the executing game together with frame rendering and encoding on the game server. This latency value can be determined for example conducting measurements on the host where the game server 121 runs or making use of estimations based on the cloud game instance and the allocated compute resources.

Action 707. The latency evaluator 601 may then calculate or determine a least amount of compute resources required to reach the said compute latency gain. For example, the latency evaluator 601 may use a table that lists the expected latencies of the game with different amounts of assigned compute resources. The latency evaluator 601 may choose all rows from the table that contains compute latency smaller that the target compute latency. Finally, among the selected rows, it picks the one with least amount compute resources. Note that this table can be populated when the game server 121 starts on the server and the values depends on the game itself as well as the hardware parameters of the host where the game server 121 will be run.

Action 708. Then, the latency evaluator 601 may construct and send a Scale-up request to the resource manager 605 that carries the hardware resources calculated in previous action.

Action 709. The latency evaluator 601 may then initiate the reconfiguration of the jitter buffer 600 at the game client 101 by setting a lower and higher bounds of the target delay value to the current delay target. Thus, the jitter buffer 600 will not be able to decrease below the current delay target level and therefore it will not cause subsequent glitches in the video playout caused by decreasing the delay target. Finally, the procedure finishes.

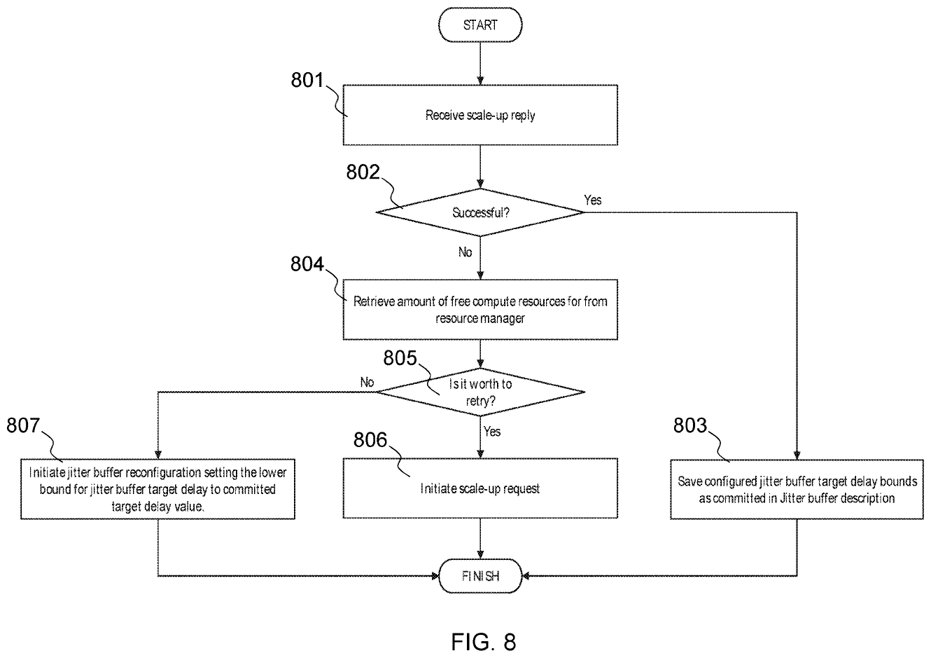

FIG. 8 presents the procedure that the latency evaluator 601 executes when it receives a response from the resource manager 605. This response is for the request sent from the latency evaluator requesting compute resources, and the response may indicate whether the Scale up request was successfully resolved, i.e., the new amount compute resources are allocated, or there were any failures. The procedure comprises of the following actions:

Action 801. The latency evaluator 601 may receive the response such as a Scale up reply message from the resource manager 605.

Action 802. The latency evaluator 601 may then check if the response indicates the successful update of compute resources of a game server 121.

Action 803. If so, the decrease of compute latency compensates the increased jitter buffer latency and it is safe to use the candidate jitter buffer delay bounds in long run. Therefore, the procedure saves the configured jitter buffer delay target bounds as committed in the Jitter buffer description and finishes.

Action 804. Otherwise, the latency evaluator 601 may retrieve the amount of free compute resources from the resource manager 605 that can be assigned to the game server 121 as well.

Action 805. The latency evaluator 601 may check whether the amount additional resources allow decreasing the compute latency at a such level that it is worth to use. For example, the latency evaluator 601 may use the said table defining relation of compute latencies and allocated hardware resources. Then the latency evaluator 601 may add the available free resources to the currently allocated ones and read the compute latency value belonging to the increased amount of compute resources. If the difference of this calculated compute latency and the measured one exceeds a predefined threshold, it is worth to request for the additional free resources.

Action 806. The latency evaluator 601 may then, when it is worth to allocate the free resource to the game server 121 as well, construct and may send another Scale up request, also referred to as the other request, to the resource manager 605 considering the available free resources and the finishes.

Action 807. The latency evaluator 601 may otherwise, when it is not worth to allocate additional resources to the game server 121, with the available additional compute resources it is not possible to compensate the increased end-to-end latency. Then, the lower bound of the jitter buffer delay target has increased in the action 709 would fix the end-to-end game latency above the latency threshold. Therefore, the latency evaluator 601 may re-configure the jitter buffer with target delay bounds used prior the increase, i.e., it uses the last committed delay bounds stored in the jitter buffer descriptor. Then the procedure finishes.

In the case, when a subset of the requested additional compute resources is available only, the compute resources are not enough to fully compensate the latency increase caused by the jitter buffer. Then, though the end-to-end game latency exceeds the given target value, the video glitches caused by jitter buffer adaptations may be eliminated.

When exceeding the target end-to-end game latency is not acceptable, the latency evaluator 601 may be configured not to retry the scale-up request to use the free compute resources, which is less than the originally requested one.

There can be implementations of the resource manager 605 that does not allow the latency evaluator 601 to obtain the free resources available to the game server 601. In that case the procedure can omit the retrieving of the additional free resources and it will select the no branch at the decision point of “Is it worth to retry?”.

It should be noted that the latency evaluator 601 may run in the server node 12 such as the game server 121. A component calculating compute resources may be implemented in distributed fashion, i.e., one instance can run at each server node 12. Then the component is responsible for the server node 12 where it runs. The component calculating the compute resource needed may also run as a dedicated software component accepting resource adjustment requests from one or several server nodes. The server nodes under control of a resource calculator can be for example all servers belonging to a network function virtualization infrastructure (NFVI) instance, e.g., a data centre, or even several such NFVI instances.

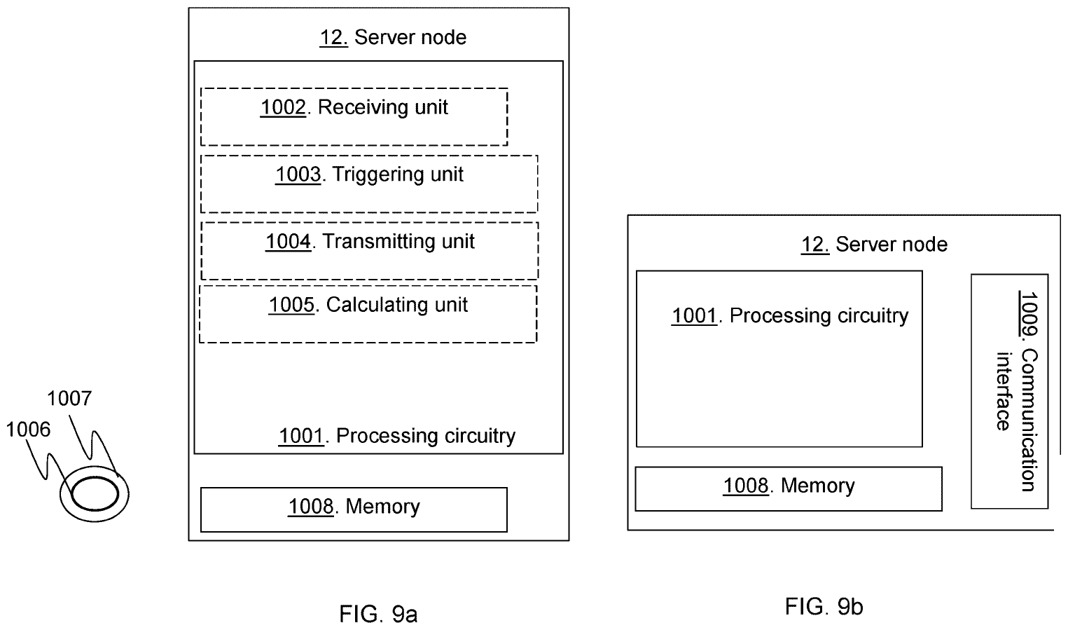

FIG. 9a and FIG. 9b depict in block diagrams two different examples of an arrangement that the server node 12 for handling the media related session with the client device 10 in the communication network may comprise. The media related session may comprise a gaming session.

The server node 12 may comprise processing circuitry 1001, e.g., one or more processors, configured to perform the methods herein.

The server node 12 may comprise a receiving unit 1002, e.g., a receiver or a transceiver. The server node 12, the processing circuitry 1001 and/or the receiving unit 1002 is configured to receive from the client device 10, the indication of the buffer size related to the media related session.

The server node 12 may comprise a triggering unit 1003, e.g., a receiver or a transceiver. The server node 12, the processing circuitry 1001 and/or the triggering unit 1003 is configured to trigger the increase of the one or more compute resources in the communication network to handle the media related session based on the received indication. The server node 12, the processing circuitry 1001 and/or the triggering unit 1003 may be configured to trigger the increase of the one or more compute resources by sending to the resource manager, managing compute resources in the communication network, the request to add the one or more compute resources to handle the media related session. The server node 12, the processing circuitry 1001 and/or the triggering unit 1003 may further be configured to receive the response from the resource manager whether the request is granted or not. The server node 12, the processing circuitry 1001 and/or the triggering unit 1003 may further be configured to, when the response is indicating that the request is not granted, send another request to the resource manager based on the received response. The response may indicate the amount of available resources and the server node 12, the processing circuitry 1001 and/or the triggering unit 1003 may be configured to compare the available resources with an indication of latency decrease.

The server node 12 may comprise a transmitting unit 1004, e.g., a transmitter or a transceiver. The server node 12, the processing circuitry 1001 and/or the transmitting unit 1004 is configured to transmit a reconfiguration message to the client device 10 indicating to the client device 10 not to decrease the buffer size during the media related session.

The server node 12 may comprise a calculating unit 1005. The server node 12, the processing circuitry 1001 and/or the calculating unit 1005 may be configured to calculate the amount of compute resources needed based on the received indication of the buffer size. The one or more compute resources may comprise one or more processing resources in a cloud computing environment, and the client device 10 may be a wireless communication device.

The server node 12 may comprise a memory 1008. The memory 1008 comprises one or more units to be used to store data on, such as data packets, processing time, video packets, tables of compute resource vs delay or buffer size, measurements, events and applications to perform the methods disclosed herein when being executed, and similar. Furthermore, the server node 12 may comprise a communication interface 1009 such as comprising a transmitter, a receiver, a transceiver and/or one or more antennas.

The methods according to the embodiments described herein for the server node 12 are respectively implemented by means of e.g., a computer program product 1006 or a computer program, comprising instructions, i.e., software code portions, which, when executed on at least one processor, cause the at least one processor to carry out the actions described herein, as performed by the server node 12. The computer program product 1006 may be stored on a computer-readable storage medium 1007, e.g., a disc, a universal serial bus (USB) stick or similar. The computer-readable storage medium 1007, having stored thereon the computer program product, may comprise the instructions which, when executed on at least one processor, cause the at least one processor to carry out the actions described herein, as performed by the server node 12. In some embodiments, the computer-readable storage medium may be a transitory or a non-transitory computer-readable storage medium. Thus, embodiments herein may disclose a server node 12 for handling the media related session with the client device 10 in the communication network, wherein the server node comprises processing circuitry and a memory, said memory comprising instructions executable by said processing circuitry whereby said server node 12 is operative to perform any of the methods herein.

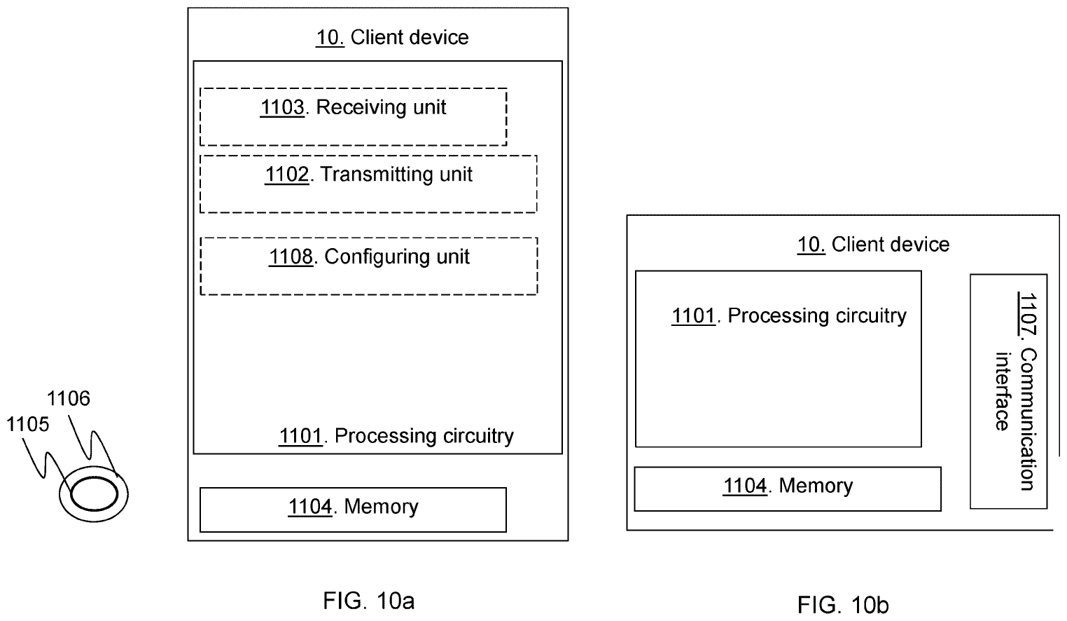

FIG. 10a and FIG. 10b depict in block diagrams two different examples of an arrangement that the client device 10 for handling the media related session with the server node 12 in the communication network may comprise. The client device may comprise a buffer such as a jitter buffer. The media related session may comprise a gaming session. The client device 10 may be a wireless communication device.

The client device 10 may comprise processing circuitry 1101, e.g., one or more processors, configured to perform the methods herein.

The client device 10 may comprise a transmitting unit 1102, e.g., a transmitter or a transceiver. The client device 10, the processing circuitry 1101 and/or the transmitting unit 1102 is configured to transmit to the server node 12, the indication of the buffer size related to the media related session. The client device 10, the processing circuitry 1101 and/or the transmitting unit 1102 may be configured to transmit the indication when the buffer size is above the threshold.

The client device 10 may comprise a receiving unit 1103, e.g., a receiver or a transceiver. The client device 10, the processing circuitry 1101 and/or the receiving unit 1103 is configured to receive, from the server node 12, the reconfiguration message indicating to the client device 10 not to decrease the buffer size during the media related session.

The client device 10 may comprise a configuring unit 1108. The client device 10, the processing circuitry 1101 and/or the configuring unit 1108 may be configured to configure one or more bounds of the buffer based on the received reconfiguration message.

The client device 10 may comprise a memory 1104. The memory 1104 comprises one or more units to be used to store data on, such as data packets, processing time, video packets, delay or buffer size, measurements, events and applications to perform the methods disclosed herein when being executed, and similar. Furthermore, the client device 10 may comprise a communication interface 1107 such as comprising a transmitter, a receiver, a transceiver and/or one or more antennas.

The methods according to the embodiments described herein for the client device 10 are respectively implemented by means of e.g., a computer program product 1105 or a computer program, comprising instructions, i.e., software code portions, which, when executed on at least one processor, cause the at least one processor to carry out the actions described herein, as performed by the client device 10. The computer program product 1105 may be stored on a computer-readable storage medium 1106, e.g., a disc, a universal serial bus (USB) stick or similar. The computer-readable storage medium 1106, having stored thereon the computer program product, may comprise the instructions which, when executed on at least one processor, cause the at least one processor to carry out the actions described herein, as performed by the client device 10. In some embodiments, the computer-readable storage medium may be a transitory or a non-transitory computer-readable storage medium. Thus, embodiments herein may disclose a client device 10 for handling the media related session with the server node 12 in the communication network, wherein the client device 10 comprises processing circuitry and a memory, said memory comprising instructions executable by said processing circuitry whereby said client device 10 is operative to perform any of the methods herein.

In some embodiments a more general term “network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However, the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a server node (12) for handling a media related session with a client device (10) in a communication network, the method comprising:
receiving (402), from the client device, an indication of a buffer size related to the media related session; and
triggering (404) an increase of one or more compute resources in the communication network to handle the media related session based on the received indication.

2. The method according to claim 1, further comprising
transmitting (405) a reconfiguration message to the client device (10) indicating to the client device (10) not to decrease the buffer size during the media related session.

3. The method according to claim 1, wherein triggering (404) comprises sending to a resource manager managing compute resources in the communication network, a request to add the one or more compute resources to handle the media related session.

4. The method according to the claim 3, wherein triggering (404) further comprises receiving a response from the resource manager whether the request is granted or not.

5. The method according to the claim 4, wherein the response is indicating that the request is not granted, and wherein the triggering further comprises sending another request to the resource manager based on the received response.

6. The method according to claim 1, further comprising
calculating (403) an amount of compute resources needed based on the received indication of the buffer size.

7. The method according to claim 1, wherein the media related session comprises a gaming session.

8. The method according to claim 1, wherein the one or more compute resources comprise one or more processing resources in a cloud computing environment, and the client device is a wireless communication device.

9. A method performed by a client device (10) for handling a media related session with a server node (12) in a communication network, the method comprising:
transmitting (501) to the server node (12), an indication of a buffer size related to the media related session; and
receiving (502), from the server node, a reconfiguration message indicating to the client device (10) not to decrease the buffer size during the media related session.

10. The method according to claim 9, wherein transmitting the indication is performed when the buffer size is above a threshold.

11. The method according to claim 9, wherein the media related session comprises a gaming session.

12. The method according to claim 9, further comprising
configuring (503) one or more bounds of a buffer based on the received reconfiguration message.

13. (canceled)

14. A computer-readable storage medium, having stored thereon a computer program product comprising instructions which, when executed on at least one processor, cause the at least one processor to carry out a method according to claim 1, as performed by the client device and the server node, respectively.

15. A server node (12) for handling a media related session with a client device (10) in a communication network, wherein the server node is configured to:
receive, from the client device, an indication of a buffer size related to the media related session; and
trigger an increase of one or more compute resources in the communication network to handle the media related session based on the received indication.

16. The server node (12) according to claim 15, wherein the server node is further configured to
transmit a reconfiguration message to the client device (10) indicating to the client device (10) not to decrease the buffer size during the media related session.

17. The server node (12) according to claim 15, configured to trigger the increase of the one or more compute resources by sending to a resource manager managing compute resources in the communication network, a request to add the one or more compute resources to handle the media related session.

18. The server node (12) according to the claim 17, configured to trigger the increase of the one or more compute resources by receiving a response from the resource manager whether the request is granted or not.

19. The server node (12) according to the claim 18, wherein the response is indicating that the request is not granted, and wherein the server node is further configured to send another request to the resource manager based on the received response.

20-22. (canceled)

23. A client device (10) for handling a media related session with a server node (12) in a communication network, wherein the client device is configured to:
transmit to the server node (12), an indication of a buffer size related to the media related session; and
receive, from the server node (12), a reconfiguration message indicating to the client device (10) not to decrease the buffer size during the media related session.

24. The client device (10) according to claim 23, wherein the client device is configured to transmit the indication when the buffer size is above a threshold.

25-27. (canceled)
